(19) United States
(12) Patent Application Publication
(10) Pub. No.: US 2013/0018803 A1
(43) Pub. Date: Jan. 17, 2013

(54) SYSTEM AND METHOD FOR PROVIDING TECHNICAL SUPPORT THROUGH A REMOTE SESSION

(71) Applicant: Udhayan Challu, Gurgaon (IN)

(72) Inventor: Udhayan Challu, Gurgaon (IN)

(73) Assignee: IYOGI LIMITED, Port Louis (MU)

(21) Appl. No.: 13/637,095

(22) PCT Filed: Jul. 5, 2010
(86) PCT No.: PCT/IB10/01641

§ 371 Date: Sep. 25, 2012

(30) Foreign Application Priority Data
Mar. 26, 2010 (IN) 729/DEL/2010

(51) Int. Cl. G06Q 50/10

(52) U.S. Cl. 705/304

(57) ABSTRACT

A system and computer implemented method for providing technical support through a remote session. The method begins by receiving, at a customer support servicer, a customer support request. Next, a customer support server routes the customer support request to an available analyst based on one or more conditions. The method proceeds to commence a remote session between a user's computing device and the available analyst's computing device. The issue/query is identified next, followed by generation of an action plan to solve the issue. Following this, the analyst transfers the remote session and the action plan to a technician. Finally, the technician implements the action plan on the remote session to solve the user query.

### BACKGROUND OF THE INVENTION

The present application relates generally to technical support services, and more particularly, to systems and methods for providing technical support through remote sessions.

Technical support is a range of services providing assistance with technology products such as mobile phones, televisions, computers, or other electronic or mechanical goods. In general, technical support services attempt to help a user solve specific problems with a product.

Technical support is often subdivided into tiers, or levels, in order to better serve a business or customer base. The number of levels a business uses to organize their technical support group is dependent on a business' need, want, or desire as it revolves around their ability to sufficiently serve their customers or users. Technical Support centers, typically, follow a “pyramid” approach to problem-solving where technical support executives of varying knowledge, education, skill set, and experience are divided into different tiers of the pyramid. Highly experienced or adept executives are classified in the highest tier, while new recruits or executives with minimal skill set or qualification are classified in the lowest tier. At any time, the number of adept executives is lower than the number of new recruits or lower skill set tier executives, resulting in a pyramid shaped hierarchical structure.

Here, a user inquiry is first forwarded to an executive in the lowest tier of the pyramid; if the executive is unable to solve to user's query, the user inquiry is forwarded to an executive in the next level. Here again, if the executive is unable to solve the user's problem, the request is forwarded to an executive in the highest tier. As these executives are proficient at solving almost any query or problem that a customer may encounter, the customer query is usually solved at the end of this process.

Success of the organizational structure is dependent on the technicians' understanding of their level of responsibility and commitments, their customer response time commitments, and their understanding of timely escalation of important issues to the right level. Following this approach for difficult or uncommon queries, however, raises a number of problems. For instance, each time an executive is unable to solve the user's query; the user call is forwarded to an available executive in the next tier, where the user has to repeat the query. Further, this repetition may be required a third time if the second tier executive is unable to help either. This query forwarding within the technical support centre can be very annoying for a customer. Moreover, the hierarchical forwarding of customer calls increases the average call handling time, thereby reducing call centre profits and efficiency.

As a result, there exists a need for improved technical support systems and methods configured to reduce the average call handling times and improve customer satisfaction.

### BRIEF DESCRIPTION OF THE INVENTION

One embodiment of the present application describes a computer implemented technical support method for solving computer related technical queries. The method begins by receiving, at a technical support center, a customer support request. Next, the method commences a remote session between a user's computing device and an available analyst's computing device. The issue/query is identified next, followed by generation of an action plan to solve the issue. Following this, the analyst transfers the remote session and the action plan to a technician. Finally, the technician implements the action plan on the remote session to solve the user query.

Another embodiment of the present application describes a technical support system for troubleshooting computer related user issues. The system includes a customer support server for receiving a customer support request from a user, and initiating a remote session between the user and an analyst, wherein the analyst identifies the user issue and determines an action plan to solve the issue. The customer support server further transfers the remote session along with the action plan to a specified technician, wherein the technician implements the action plan on the remote session to solve the issue. Further, the system includes a call-center management system for retrieving the user's identification number from the customer support server, and setting up a voice session between the analyst and the user using the user's identification number.

Yet another embodiment of the present disclosure describes a computer-implemented method for initiating a remote session for a customer service request. The method begins by receiving a customer service request. Next, the method retrieves request information comprising at least one of customer demographics, computing device information, preferred technician, preferred time, or nature of request. Following this step, the method obtains queue information, and determines the optimum request routing path based on the request information and the queue information. Finally, the method initiates a remote session on the optimum path.

Still another embodiment of the present application describes a system for initiating a remote session for a customer service request. The system comprises a customer support server for receiving a customer service request, and a request module configured for retrieving request information comprising at least one of customer demographics, computing device information, preferred technician, preferred time, or nature of request. The system further includes a routing module for obtaining queue information, and determining the optimum request routing path based on the request information and the queue information. Finally, the system includes a launcher for initiating the remote session on the optimum request routing path.

Embodiments of the present disclosure provide many advantages. For example, the technical support method not only reduces the average call handling times, but also improves customer satisfaction; and increases support centre efficiency, and resource utilization.

These and other advantages, features, and objects of the present application will become apparent upon review of the following detailed description of the preferred embodiments when taken in conjunction with the drawings and the appended claims.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment. The drawings are illustrative in nature and are not necessarily drawn to scale.

FIG. 1 illustrates an exemplary remote technical support system according to some embodiment of the present disclosure.

FIG. 2 illustrates an exemplary self-support tool according to some embodiments of the present disclosure.

FIG. 3 is a flowchart illustrating an exemplary method for providing remote technical support according to some embodiments of the'present disclosure.

FIG. 4 is a flow chart illustrating an exemplary method for routing customer service requests according to some embodiments of the present disclosure.

FIG. 5 is a flowchart illustrating an exemplary method for automatically resolving technical defects according to some embodiments of the present disclosure.

### DETAILED DESCRIPTION OF THE INVENTION

For promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments and any further applications of the principles of the disclosure as illustrated therein are contemplated as would normally occur to one skilled in the art to which the disclosure relates. All limitations of scope should be determined in accordance with and as expressed in the claims.

The following terms are used throughout this document and are defined here for clarity and convenience.

Remote Technical Support—method for troubleshooting software related problems via remote desktop connections. Technicians use software that allows the technician to access the user's desktop via the Internet. With the user's permission, the technician can take control of the user's mouse and keyboard, transfer various diagnostic and repair applications to the user's desktop, run scans, install antivirus programs, etc. If the remote service permits it, the technician can even reboot the PC and reconnect remotely to continue his work without the user needing to assist. Common repairs available with online computer support providers are computer virus and spyware removal, computer optimization, registry repair, device driver issues, Web related issues, and Windows security updates. Generally, only software can be “repaired” remotely; a computer with a broken hardware component such as a motherboard or hard disk, in some cases, can be diagnosed, but must be repaired in person.

Analyst/Level 3 (L3)—the highest level of support in a three-tiered technical support model responsible for handling troubleshooting and problem analysis. These individuals are experts in their fields and are responsible for not only assisting lower order technicians, but with research and development of solutions to new or unknown issues. The first job of an L3 analyst is to determine the customer's issue by analyzing the symptoms and figuring out the underlying problem. Once identification of the underlying problem is established, the analyst can begin sorting through possible solutions available to develop one or more action plans, and forwarding the action plan to lower order technicians for implementing the action plan.

Technician/Level 1(L1)—the lowest level of support in a three-tiered technical support model responsible for basic action plan implementation. Personnel at this level have a basic to general understanding of the product or service and may not always have the competency required for solving complex issues. The Action plan developed by the L3 personnel is implemented by these technicians using basic software tools and troubleshooting guides.

Self-Support Tool—a wizard-driven application (installed on user computers) designed to detect and resolve common computer-related issues. The self-support tool can rectify a range of issues from interne connectivity, software installation, to email problems. Further, the self-support tool attempts to resolve all computer-related issues, however, if some issues remain unresolved, the tool provides easy connection to a technical support centre. Additionally, it provides information to communicate more effectively with a technical analyst at the technical support centre, drastically reducing resolution time.

### System Overview

The present application describes an improved technical support system and method to reduce the average call handling times and improve customer satisfaction. The system utilizes an inverted pyramid hierarchical structure, wherein level 3 analysts are the first point of contact for customers. This is different from the typical pyramid structure adopted by customer support centers that provides a level 1 technician as the first point of contact. To enable this model, the present application describes a remote technical support service framework for efficiently handling remote computer related service requests. The framework includes a fully functional technical support centre connected to one or more customers through the interne. Users/customers can set up remote sessions with technicians or analysts in the technical support centre for remote problem solution. For example, if a customer is facing software issues, the customer can request the support centre for a callback from an analyst. The analyst, in turn, calls the customer and sets up a remote session with the customer's computer. Subsequently, the analyst determines the problem, develops a solution, and forwards the solution to a level 1 technician for implementation. Along with the action plan, the analyst also forwards the remote session to the technician, who troubleshoots the customer problem using the developed action plan. In this manner, a substantial amount of technical support service issues can be resolved in the first step, and users do not have to repeat the problem to a representative of each organizational tier. Further, call-handling times are greatly reduced as all resolution plans are developed by level 3 personnel, and the mere implementation of the plans is forwarded to a level 1 technician.

In some embodiments, the remote technical support service framework utilizes a routing algorithm that efficiently and intelligently routes customer queries to the optimal technician. For example, if a user request originates from Japan, and the customer's operating system is Windows® Vista®, the system efficiently routes the customer request to a technician fluent in Japanese and skilled in Windows® Vista®—instead of an English-speaking technician skilled in Linux®. The routing algorithm will be described in detail during the course of this disclosure.

In some other embodiments, the customer's computer includes a self-support tool that continuously monitors the user's computer for issues or errors. Upon detecting an error, the self-support tool may attempt to solve the error itself. In case the self-support tool is unable to resolve the error, it sends the error information to the technical support centre and requests an automatic resolution from a resolution database, or requests a manual fix by a customer service representative (analyst or technician). In the second case, the customer service representative may request the user to set up a remote session to identify and correct the detected error. These and other features and advantages of the present disclosure will be described in detail with reference to the figures.

### Exemplary System

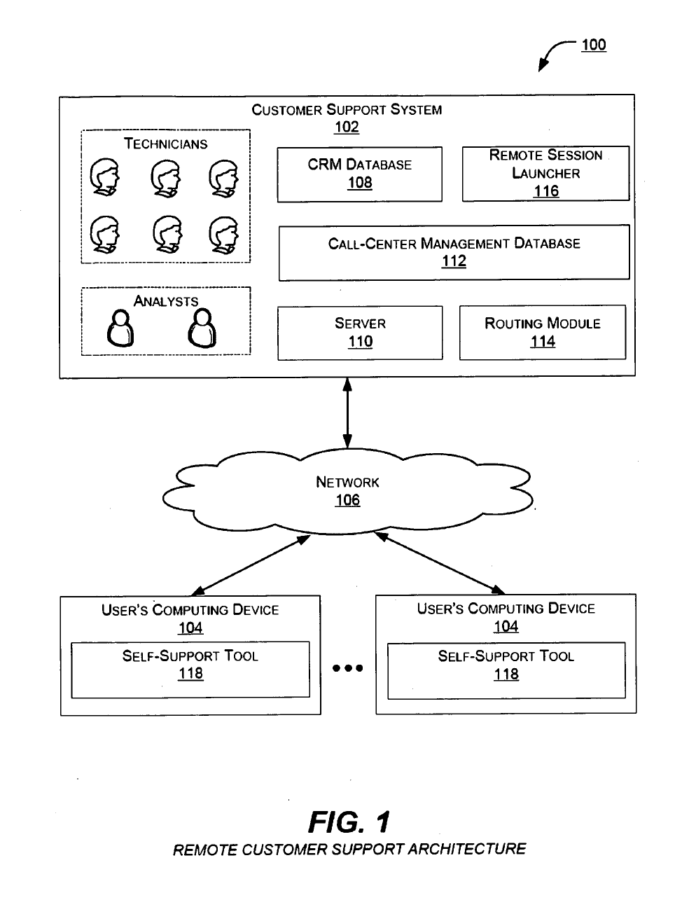

FIG. 1 illustrates an exemplary remote technical support framework 100 according to embodiments of the present disclosure. The framework includes a technical support system (TSS) or call center 102 connected to one or more user's computing devices 104 via the internet 106. The TSS 102 includes a customer relationship management (CRM) database 108, a server 110, a call-centre management database 112, a routing module 114, and a remote session launcher 116. The user's computing device 104 further includes a self-support tool 118. In addition to these software and hardware, the TSS 102 also includes multiple level 3 and level 1 personnel (analysts and technicians), who are connected to one another through an internal network. This is helpful while transferring remote sessions from analysts to technicians. The analysts can view all available technicians before transferring the session to the next available technician. In one embodiment, the analysts can transfer the session to a technician with expertise in the identified problem and/or resolution plan. Alternatively, the analyst can select any available technician randomly.

The call-centre management database 112 stores information about each analyst and technician such as name, alias, email address, contact information, workstation allocated, level of expertise, area of expertise, number of cases handled effectively, and so on. This information is used by the TSS 102 for routing service requests, and for other internal purposes such as appraisals, evaluations, and such purposes.

In addition, this database 112 also stores information pertaining to computer related errors and resolution action plans. The information is regularly refreshed or updated, from one or more external or internal sources. For example, analysts, from time to time, may develop new action plans, or modify current action plans for more efficient error resolution. Furthermore, various external computer and software manufactures regularly update software or hardware components, providing fixes, patches, and other error resolution techniques. The call-centre management database 112 may regularly query these external manufacturer databases for new action plans, fixes, patches, or other error resolution techniques and update these action plans in the database.

The CRM database 108 stores relevant information about registered users, such as user name, age, computer configuration, operating system used, previous service requests, error resolutions, unresolved errors, user profile, and so on. This information is utilized by the TSS 102 for routing requests to analysts, profiling customers, tracking their error resolution history, and so on. Further, the CRM database 108 is communicatively coupled to the call-centre management database 112 for information transfer from time to time. For example, if a customer is regularly handled by a particular analyst, the CRM database 108 may include a link to the analyst's profile present in the call-centre management database 112, and vice-versa.

The server 110 is at the heart of the call center, accepting incoming service requests, analyzing the service requests, and forwarding the requests to the routing module 114. The server 110 may be connected to the interne 106 through a firewall, router, switch, or any other device enhancing the security of the server 110. The routing module 114 receives all incoming requests, generated by the self-support tool 118 automatically, by a user, or general service requests that are not generated through the self-support tool 118. The server 110 determines the type of service request, the originating demographics, and so on. Requests through the self-support tool 118 typically include information about the user's computing system as well, such as computer configuration, user details, operating system used, or any other information describing the user's computing environment. The server 110 forwards the service request, along with the computing environment details to the routing module 114 for further processing.

The routing module 114 is intelligent software configured to route service requests in the most efficient manner to the most suitable analyst based on service request type, customer information, request details, user's demographics, computing environment details, and other such information. For example, a user in the US may generate a service request, requesting immediate resolution. From the user's IP address or any other information source, the server 110 can determine the user's demographics, and from information generated by the self-support tool 118, the server 110 may determine the user's name or ID. Then, from the CRM database 108, the server 110 can retrieve user details, and provide this information along with the service request to the request routing module 114. Here on, the request routing module 114 may apply certain rules or algorithms on the user details, service request, and analyst information (retrieved from the call centre management database 112) to determine the most suitable analyst to handle the service request.

In one illustrative example, the routing module 114 may determine that the analyst that had previously handled this customer's query should handle the service request. Alternatively, if that analyst is not available, the request routing module 114 may transfer the request to another analyst adept in the user's computing environment. In other situations, if the user wishes to select a preferred analyst, the routing module 114 will merely check whether the preferred technician is available. If yes, then the request it routed to the preferred technician, else, the routing module 114 may discern an analyst with similar experience, level of expertise, and rating, and transfer the service request to that analyst. In one embodiment, the routing module 114 may assign variable weights to one or more parameters used in the routing process, calculate a score for each route, and transfer the service request to the route with the highest score. It will be understood, however, that the routing module 114 may utilize any other technique to transfer service requests to any analyst without departing from the scope of the present disclosure.

In some cases, the user may not request immediate resolution; instead, the user may request an analyst to callback at a desired time. In these situations, the request routing module 114 takes into consideration the desired call back time, and determines which analysts are available at the desired callback time. The routing algorithm is then performed on the list of analyst available at the desired time.

The remote session launcher 116 as the name suggests, initiates remote sessions between the user's computing device 104 and the computer of the selected analyst at the time of request resolution. To this end, the session launcher 116 may determine internet connectivity between the user and the analyst, Internet speed, and any other parameters that may affect the remote session. Upon detection of internet connectivity, the remote session launcher 116 proceeds to set up the remote session.

Along with these components, the technical support framework 100 includes a voice module (not shown in FIG. 1). This module is responsible for setting up voice sessions between the user and the selected analyst. To this end, the voice module retrieves the user's phone number from the CRM database 108. In other embodiment, users may contact the call centre proactively. In these cases, the voice module transfers the user's voice session to the selected analyst. It will be understood that the voice module is sufficiently known in the call centre environment, and its merits will not be described in detail here.

Further, it will be understood that the TSS 102 may include numerous other modules, software, or hardware components, such as interactive voice response (IVR) systems, caller identification systems, PC call control software, unified voice/fax/e-mail messaging systems, IP telephony, music-on-hold, text chat software, Web co-browsing, and other customer support software. These systems are known in the art and will not be described here, however, it will be understood that these modules may be present in the technical support centre without departing from the scope of the present disclosure.

The self-support tool 118 may be software, hardware, or a combination component installed on the user's computing system. This tool provides data and retrieves information from the TSS 102 components, such as the server 110, the CRM database 108, the call-centre management database 112, and the remote session launcher 116. The self-support tool 118 may include one or more modules or components to carry out various operations. For example, the self-support tool 118 may include a module for monitoring the computing device and detecting any faults or errors on the device, such as virus attacks, improper software functioning, outdated software, functionality issues with auxiliary devices (e.g., printers, scanners, portable devices, etc.).

In one embodiment, the self-support tool 118 monitors the user's computing device 104 and upon error detection attempts to resolve the error. The tool 118 may resolve the error using one of two techniques. According to the first technique, the tool 118 may query an onboard error repository for possible resolutions or query the call-centre management database 112 for possible error resolution techniques. According to the second technique, the tool 118 may send an error or log report to an analyst for troubleshooting. The analyst may then determine the resolution and send a resolution code to the self-support tool 118 for implementation. The tool 118 in turn implements the code and reports the outcome (successful or unsuccessful) to the user and the analyst or the repository.

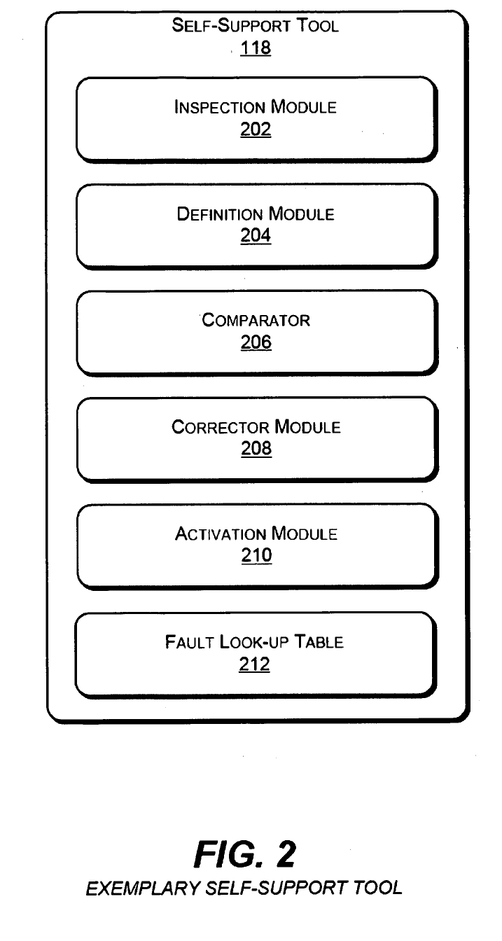

In an alternate embodiment, the self-support tool 118 may be utilized by the user to send service requests whenever the user detects a problem or error. In this embodiment, the user may send the service request along with immediate or scheduled callback request to the technical support centre. Here, the service request is routed to the optimal analyst for resolution, and the typical error resolution process described in this disclosure is followed thereon. Detailed functionality of the self-support tool 118 will be described later with reference to FIG. 2.

### Exemplary Self-Support Tool

FIG. 2 depicts an exemplary self-support tool 118 according to embodiments of the present disclosure. The tool includes one or more modules configured to provide various tool functionalities, such as an inspection module 202 for scanning a user's computing device 104 for a fault; a definition module 204 for identifying the fault; and a comparator 206 for comparing the identified fault with a list of known faults to determine the type of fault. A corrector module 208 obtains corrective measures for the known fault, and applies the corrective measures to the identified fault. Moreover, the self-support tool 118 includes an activation module 210 for advising the user of the identified fault (by displaying an alert or a message, sending an email, etc.), and activating a remote session if the identified fault cannot be automatically corrected. It will be understood that these modules from time to time may interact with the TSS 102 to provide data, retrieve information, perform calculations, request analysis, and to perform other such tasks. Moreover, some of these modules may be present on the user's computing device 104, while others may be present at the TSS 102. For example, the inspection module 202 may be present on the user's computing device 104, while the corrector module 208 may be present at the TSS 102.

The inspection module 202 monitors the user's computing device 104 regularly and generates log or error reports whenever it detects an error or fault. Errors may include programs not responding, virus detection, device driver errors, outdated software, and so on.

The definition module 204 identifies the type of fault, and in some instances classifies the fault according to one or more preconfigured fault categories. For example, the module may be configured with different levels for faults, such as “minor,” “major,” “catastrophic,” “repairable,” “software fault,” “hardware fault,” and so on. The definition module 204 may then classify an identified fault under one or more of these categories. This can be useful while prioritizing service requests at the technical support centre, or while routing these requests. Illustratively, a “catastrophic” or “major” fault may be given higher priority in a service request queue. Moreover, “major” faults may be routed to highly adept analysts, while “minor” faults may be routed to less experienced analysts.

The definition module 204 may also identify the fault on a higher level, by actually characterizing the fault into one or more predefined, standard fault formats. For example, the error report may state that an error occurred during the normal functioning of a printer. In turn, the definition module 204 may utilize a look-up table, such as a fault look up table 212, to obtain a list of printer related faults and determine the exact nature of the fault. The fault look-up table 212 may be updated from various external manufacturer portals, service manuals, administrator, or user manuals.

Alternatively, the look-up table 212 may also be populated by faults identified by analysts and technicians of the TSS 102 during regular fault resolution processes. The fault look-up table 212 may be located on the customer support server 110, and each time an error is detected, the inspection module 202 may send the error report to the TSS 102, where the definition module 204 identifies and classifies the error/fault.

The corrector module 208 along with comparator 206 obtains a solution to the identified error or fault, utilizing one or more different techniques. According to a first technique, a resolution for the identified fault is sought in the look-up table 212. If a solution for the fault is determined from the look-up table 212, the comparator 206 retrieves the solution and the corrector module 208 implements the resolution on the user's computing device 104 to alleviate the error. The look-up table 212 may be present in the call-centre management database 112, or may be present on the user's computing device 104. According to a second technique, the comparator 206 provides the identified error along with the error report to an analyst. The analyst determines a solution, writes a solution code, which is implemented by the corrector module 208 on the user's computing device 104. Alternatively, the corrector module 208 may engage the activation module 210 and the remote session launcher 116 to organize a remote session between the user's computing device 104 and the analyst/technician's computing device. The analyst may determine a solution, and transfer the solution and the remote session to a technician, who in turn may implement the solution on the user's computing device 104. Once the error is resolved, the remote session is concluded.

### Exemplary Method(s)

The following sections describe exemplary methods according to some embodiments of the present disclosure. The order in which the methods are described is not intended to be construed as a limitation, and any number of the described method steps can be combined in any order to implement the method, or an alternate method. Additionally, individual steps may be deleted from the method without departing from the spirit and scope of the subject matter described herein. Furthermore, the method can be implemented in any suitable hardware, software, firmware, or combination thereof.

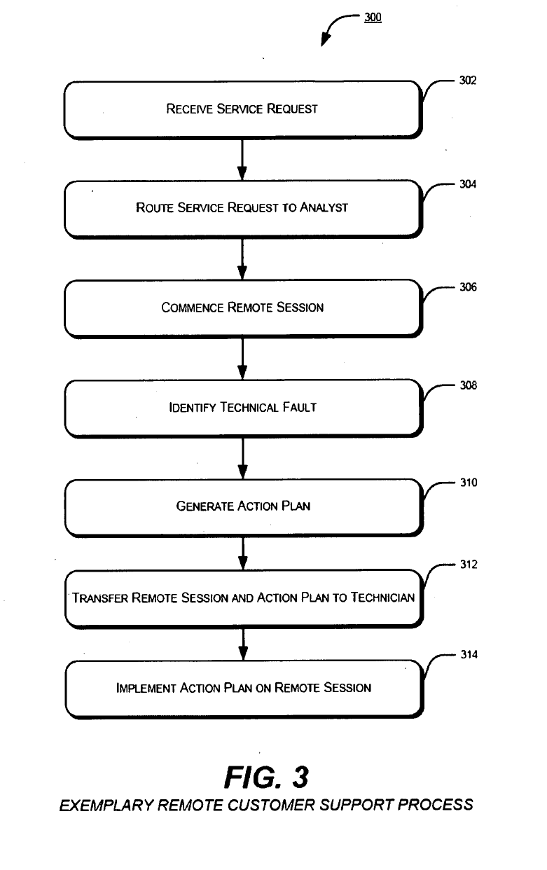

FIG. 3 is a flowchart illustrating an exemplary method for providing remote technical assistance. The method 300 includes the steps of receiving a customer support request, routing the service request to the optimal analyst, and commencing a remote session between the user and the analyst. Next, the method 300 identifies a technical fault, generates an action plan to solve the fault, transfers the remote session with the action plan to a technician, and implements the action plan to solve the technical fault.

At step 302, the method 300 receives a customer service request. The request may be generated by a user through the self-support tool 118, or may be generated automatically by the self-support tool 118 upon fault detection. Alternatively, a non-registered user may request for customer service through a voice connection with the IVR, customer service representative, or any other communication means.

At step 304, the method 300 routes the service request to the optimal analyst. To this end, the method 300 utilizes the routing module 114, which obtains user information from the self-support tool 118, the server 110, or directly from the user, service request information, and preferred analyst information. Further, the routing module 114 obtains queue information, such as analyst availability, technician availability, estimated queue time, and so on. Based on the retrieved information, the routing module 114 determines the most suitable analyst for a user. As an illustrative example, the routing module 114 may transfer the service request to the preferred analyst, if the analyst is available. Alternatively, the routing module 114 may set up a callback appointment with the preferred analyst, if the analyst is not currently available, or if the user requests a callback at a desired time.

At step 306, the method 300 commences a remote session between the user and the selected analyst using the remote session launcher 116, which sends session initiation information to the activation module 210, which in turn acknowledges the request and sets up the remote session. Any known handshake signals or protocols may be utilized to setup the remote session. Further any known network or transport protocols may be utilized for transferring information between the analyst's computing device and the user's computing device 104 without departing from the scope of the present disclosure.

At step 308, the analyst communicates with the client, through a web chat, voice call, internet call, VOIP session, or any other known communication methods to determine the fault. Typically, user's may not be aware of the reason for malfunction, for example, a user may simply state that his/her printer is not functioning. The analyst then has to identify the fault, either by checking the user's computing device 104 through the remote session, or by asking the user a few questions.

Once the analyst determines the fault, at step 310, the analyst generates an action plan to solve the fault. To this end, the analyst may refer the fault lookup table 212, refer manufacturer solutions, or if no solutions are available, the analyst may attempt to devise a solution. The generated solution or action plan is transferred to an available technician along with the active remote session between the user and the analyst, at step 312. Each analyst may be assigned a pool of technicians, and the analyst may select any available technician from the pool. In this embodiment, skill set of analysts may be matched with the technician's skill sets to achieve maximum efficiency. Alternatively, all technicians may be available for an analyst to select from. In this case, the analyst may select any random technician that is available.

Finally, at step 314, the technician implements the action plan on the user's computing device 104 through the remote session. In one embodiment, the analyst can monitor the technicians work and interrupt in case the technician is unable to implement the solution. In this manner, an analyst may monitor more than one active session that have been transferred to technicians. Due to this transfer between the analyst and the technician, analyst may utilize their time efficiently by merely devising solutions or action plans, and transferring the menial task of implementing the solution to a technician who is not as adept as the analyst at problem solving. Further, this organizational structure ensures that the average call handling time is kept to minimum, and the user does not have to repeat the problem to each level of the organization for complex issues.

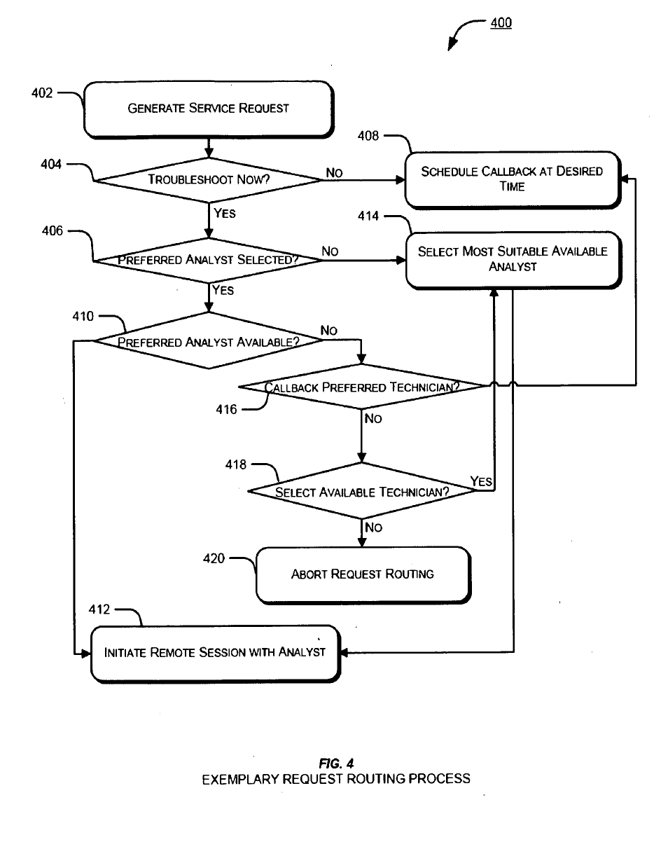

FIG. 4 is a flowchart illustrating an exemplary method 400 for routing service request to the optimal analyst. The method 400 begins at step 402, where support request is generated by the user through the self-support tool 118, or automatically by the self-support tool 118.

At step 404, the method 400 determines whether the user desires resolution immediately or at a desired time in the future. If the user desires immediate assistance, the method 400 moves to step 406, else the method 400 proceeds to step 408.

The method at step 406 determines whether the user has selected a preferred analyst. If yes, the self-support tool 118 transmits the service request along with the preferred technician information to the routing module 114, which determines whether the preferred analyst is available immediately at step 410. If the technician is available, at step 412, the service request is routed to the preferred analyst and the remote session launcher 116 initiates a remote session between the preferred analyst's computing device, and the user's computing device 104. If the preferred analyst is not available, the routing module 114 may present the user with a number of options. For example, at step 416, the module may depicts the analysts available and ask the user if the user would prefer a callback at the availability time; if yes, the method proceeds to step 408 and the callback is scheduled. Else, the module may ask the user if he/she would like to proceed with the next available analyst. If the user agrees, the method proceeds to step 414 and the most suitable available analyst is selected. Else, the method is aborted at step 420.

If the user has not selected a preferred analyst, the routing module 114 routes the service request to the next available analyst at step 414. In one embodiment, the routing module 114 analyses other information received along with the service request, such as user name, user profile, user's computing environment, previously solved request, previously utilized analyst, user demographics, and so on to determine the most suitable analyst for the user. To this end, the routing module 114 may assign weights to each of these parameters, and calculate a score or a band for the request. Based on the score, or the band, the routing module 114 determines which analyst to assign to the service request. For example, the routing module 114 may classify a service request as high profile windows Vista, and then the routing module 114 may select any available analyst from a list of analysts adept in Windows Vista, who handle high priority user requests.

For scheduling a callback at the desired time, the method determines if the user has selected a preferred analyst. If yes, the routing module 114 determines availability of the analyst at the desired time. Else, the routing module 114 schedules a callback with the most suitable analyst at the desired time. If the user has not selected a preferred analyst, the method selects the most suitable analyst available at the callback time and schedules the callback.

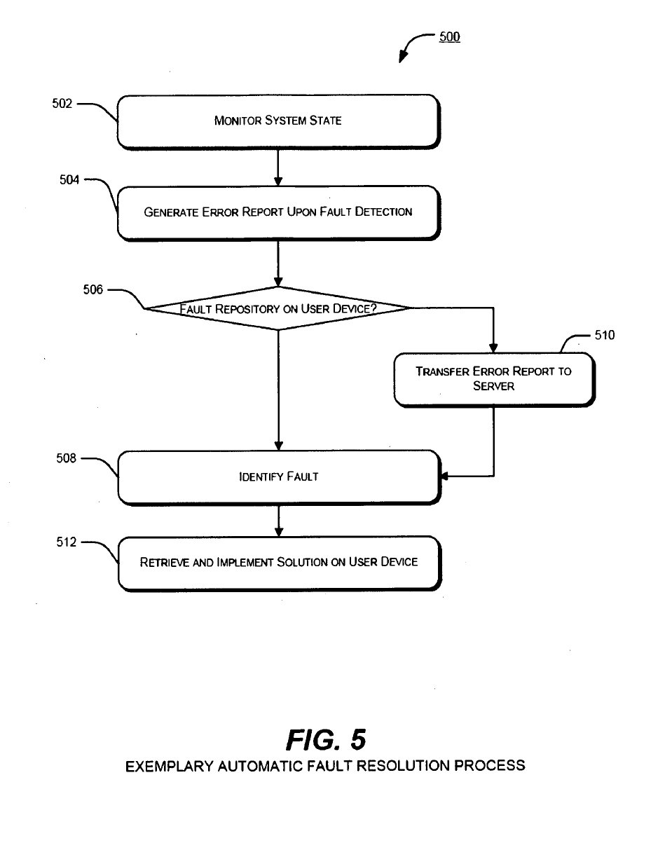

FIG. 5 is a flowchart illustrating an exemplary method for automatic fault resolution according to some embodiment of the present disclosure. As described previously, in some embodiment, the self-support tool 118 attempts to fix faults automatically. If these fixes don't work, the self-support tool 118 may inform the user of the fault and request the user to generate a service request so that an analyst may resolve the error through the remote session, by using method 300.

Method 500 begins at step 502, where the self-support tool 118 monitors the state of the user's system regularly.

At step 504, the monitoring agent detects a defect, and generates an error report. Next, at step 506, the method 500 determines whether the user's computing machine includes a repository of defect definition and solutions. If yes, the detected fault is compared with the defect definitions stored in the onboard repository to determine the type of defect, at step 508. Else, the error report is transferred to the server 110. Here, the error is compared with a repository of faults to determine the type of detect at step 508.

Next (step 510), the method 500 retrieves and implements a solution for the identified defect. A number of possibilities are feasible here. According to a first possibility, the user's computing device 104 includes the repository of faults and their resolutions. In this case, the resolution is implemented on the user's computing device 104 to fix the defect. In a second possibility, the repository is present on the server 110, and the server 110 sends the resolution information to the self-support tool 118 for implementation on the user's computing device 104. According to a third possibility, no implementable resolution may be available for the identified defect. In this case, the error report is forwarded to an analyst, who determines the best solution and forwards a solution code to the self-support tool 118, which implements the solution code on the user's computing device 104. According to a fourth possibility, the solution may not be automatically implementable. In this case, the server 110 informs the self-support tool 118, which in turn informs the user of the error and advises the user to generate a service request, so that an analyst may rectify the defect using method 300.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The specification has described a system suitable for providing customer support through a remote session using an inverted pyramid analyst structure. The foregoing description of the exemplary embodiments has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the systems and their practical application to enable others skilled in the art to utilize the systems and various embodiments and with various modifications as are suited to the particular use contemplated. Alternative embodiments will become apparent to those skilled in the art to which the present disclosure pertains without departing from their spirit and scope. Accordingly, the scope of the present disclosure is defined by the appended claims rather than the foregoing description and the exemplary embodiments described therein.

1. A computer implemented technical support method comprising:
receiving, at a customer support server, a customer support request initiated by a user;
routing the customer support request to an optimal analyst;
commencing a remote session between the user and the analyst;
identifying an issue through the remote session;
generating an action plan to solve the issue;
transferring, through the customer support server, the remote session with the action plan to a technician; and
implementing, by the technician, the action plan on the remote session to solve the issue.

2. The computer-implemented method as claimed in claim 1 further comprising generating, at a self-support tool, a customer support request;

3. The computer-implemented method as claimed in claim 2, wherein the generating step includes selecting a preferred analyst from a list of available analysts.

4. The computer-implemented method as claimed in claim 1, wherein the receiving step includes receiving one of a request to initiate a remote session, or a request for a scheduled call-back.

5. The computer-implemented method as claimed in claim 4 further comprising automatically, through a call centre management system, setting-up a call to the user at the scheduled time.

6. The computer-implemented method as claimed in claim 1 further comprising retrieving, from the customer support server, user identification.

7. The computer-implemented method as claimed in claim 6 further comprising fetching user profile information from a system memory based on the retrieved user identification.

8. The computer-implemented method as claimed in claim 1 further comprising determining, at the customer support server, internet connectivity at the user's end.

9. A technical support system for troubleshooting computer related user issues, the system comprising:
a customer support server for:
receiving a customer support request from a user;
initiating a remote session between the user and an analyst, wherein the analyst identifies the user issue and determines an action plan to solve the issue;
transferring the remote session along with the action plan to a specified technician, wherein the technician implements the action plan on the remote session to solve the issue; and
a call center management system for:
retrieving the user's identification number from the customer support server; and
setting up a voice session between the analyst and the user using the user's identification number.

10. The system as claimed in claim 9 further comprising a self-support tool for generating the customer support request;

11. The system as claimed in claim 10, wherein the self-support tool includes
a remote session launcher, and
an automatic call-back module.

12. The system as claimed in claim 11, wherein on selecting the automatic call-back module, the module requests the user to select an appropriate call-back time.

13. The system as claimed in claim 11, wherein on selecting the automatic call-back module, the module prompts the user to select a preferred analyst from a list of available analysts.

14. The system as claimed in claim 11, wherein the automatic call-back module further transmits a message to the customer support server to initiate a call-back.

15. The system as claimed in claim 9, wherein the customer support server further transmits user identification information to the call centre management system.

16. The system as claimed in claim 9, wherein the self-support tool determines internet availability at the user's computing device.

17. The system as claimed in claim 9, wherein the customer support server transfers one or more remote sessions to the analyst.

18. The system as claimed in claim 9, wherein the customer support server transfers one remote session from the analyst to the technician.

19. A technical support system comprising:
a self-support tool installed on a users computing device, the self-support tool including:
a call-back module configured to send a message to a customer-support server requesting a call-back service; and
an activation module configured to:
send a remote session request to a customer-support server;
receive confirmation from the customer-support server; and
initiate the remote session.

20. A computer-implemented method for initiating a remote session for a customer service request comprising:
receiving a customer service request;
retrieving request information comprising at least one of customer demographics, computing device information, preferred technician, preferred time, or nature of request;
obtaining queue information;
determining the most optimum request routing path based on the request information and the queue information; and
initiating a remote session on the most optimum path.

21. The computer-implemented method as claimed in claim 20 wherein the remote session is initiated if the preferred technician is available.

22. The computer-implemented method as claimed in claim 20, wherein a list of available technicians is provided to the user if the preferred technical is not available.

23. The computer-implemented method as claimed in claim 20, wherein the user can schedule a session with the preferred technician for a later time.

24. The computer-implemented method as claimed in claim 20, wherein a session is initiated with a technician proficient in the user's demographics if the user has not selected a preferred technician or if the preferred technician is not available.

25. The computer-implemented method as claimed in claim 20 wherein a session is initiated with a technician proficient in the user's customer support request if the user has not selected a preferred technician or if the preferred technician is not available.

26. The computer-implemented method as claimed in claim 20 wherein the remote session is initiated with the next available technician if the preferred technician is not available or if the user has not selected a preferred technician.

27. The computer-implemented method as claimed in claim 20 wherein the remote session is initiated at the preferred time selected by the user.

28. A system for initiating a remote session for a customer service request comprising:
a customer support server configured for:
receiving a customer service request, and
retrieving request information comprising at least one of customer demographics, computing device information, preferred technician, preferred time, or nature of request;
a routing module configured for:
obtaining queue information, and
determining the optimum request routing path based on the request information and the queue information; and
launcher for initiating the remote session on the optimum request routing path.

29. The system as claimed in claim 28, wherein the launcher initiates the remote session if the preferred technician is available.

30. The system as claimed in claim 28, the launcher displays a list of available technicians to the user if the preferred technical is not available.

31. The system as claimed in claim 28, the launcher initiates the remote session later if the user prefers to schedule a session with the preferred technician.

32. The system as claimed in claim 28, wherein the launcher initiates the remote session with a technician proficient in the user's demographics if the user has not selected a preferred technician or if the preferred technician is not available.

33. The system as claimed in claim 28, wherein the launcher initiates the remote session with a technician proficient in the user's customer support request if the user has not selected a preferred technician or if the preferred technician is not available.

34. The system as claimed in claim 28, wherein the launcher initiates the remote session with the next available technician if the preferred technician is not available or if the user has not selected a preferred technician.

35. The system as claimed in claim 28, wherein the launcher initiates the remote session at the preferred time selected by the user.

36. A computer-implemented method for providing technical support comprising:
scanning a user's computing device for a fault;
identifying the fault;
obtaining corrective measures for the known fault;
applying the corrective measures to the identified fault; and
informing user of the identified fault and the corrective measures.

37. The computer implemented method as claimed in claim 36 further comprising generating a log or error report.

38. The computer-implemented method as claimed in claim 37 wherein the identifying step is carried out by an analyst remotely by examining the log or error report.

39. The computer-implemented method as claimed in claim 36, wherein the identifying step is carried out by an automated inspection module.

40. The computer-implemented method as claimed in claim 39, wherein the inspection module is present on the user's computer, or remotely, accessible through a server.

41. The computer-implemented method as claimed in claim 39 further comprising comparing the identified fault with a list of known faults to determine the type of fault.

42. The computer-implemented method as claimed in claim 41, wherein the comparison is carried out either at the user's computing device or remotely, through a server.

43. The computer-implemented method as claimed in claim 36, wherein the corrective measures are applied to the identified fault after informing the user of the fault.

44. The computer-implemented method as claimed in claim 36 further comprising activating a remote session with an analyst if the identified fault cannot be automatically corrected.

45. The computer-implemented method as claimed in claim 36 further comprising resetting the error or log files after fault correction.

46. A system for providing technical support comprising:
an inspection module for scanning a user's computing device, at predetermined times, for a fault;
an identifier for identifying the fault
a comparator for comparing the identified fault with a list of known faults to determine the type of fault;
a corrector for:
obtaining corrective measures for the known fault;
automatically applying the corrective measures to the identified fault; and
an activation module for:
informing the user of the identified fault; and
activating a remote session if the identified fault cannot be automatically corrected.

47. The system as claimed in claim 46, wherein the inspection module generates an error or log report regularly.

48. The system as claimed in claim 47, wherein the inspection module resets the error or log reports after fault correction.

49. The system as claimed in claim 46, wherein the identifier is a customer support representative present in a remote call centre that inspects the error or log report to determine the fault.

50. The system as claimed in claim 49, wherein the identifier is present on the user's computer, or remotely, accessible through a server.

51. The system as claimed in claim 46, wherein the identifier is an automated module that inspects the error or log reports to determine the fault.

52. The system as claimed in claim 46, wherein the comparator is present on at least on one of the user's computer or a remote technical support centre.

53. The system as claimed in claim 46, wherein the corrective measures are applied to the identified fault after informing the user of the fault.

54. The system as claimed in claim 46 further comprises a remote session initiator for activating a remote session with a customer support representative if the identified fault cannot be automatically corrected.
